(19) United States
(12) Patent Application Publication
(10) Pub. No.: US 2018/0232866 A1
(43) Pub. Date: Aug. 16, 2018

(54) VEHICLE DISPLAY COMPRISING PROJECTION SYSTEM

(71) Applicant: Gentex Corporation, Zeeland, MI (US)

(72) Inventors: Andrew D. Weller, Holland, MI (US); Leah R. Hoffmeyer (nee Beck), Holland, MI (US); John C. Peterson, Grandville, MI (US)

(21) Appl. No.: 15/888,560

(22) Filed: Feb. 5, 2018

Related U.S. Application Data
(60) Provisional application No. 62/457,245, filed on Feb. 10, 2017.

(51) Int. Cl. G06T 5/00; G06T 11/60; G06T 19/00; G09G 3/00; G02B 27/22; G02B 27/01; B60R 1/12

(52) U.S. Cl. CPC G06T 5/006; G06T 11/60; G06T 19/006; G09G 3/001; G02B 27/2214; B60R 1/04; B60R 1/12; G09G 2340/12; G09G 2380/10; G02B 2027/0138; B60R 2001/1215; G02B 27/0101

(57) ABSTRACT

A display apparatus for a vehicle comprises a display screen configured to emit augmented image data in an emission direction. The apparatus further comprises a lens apparatus configured to receive the augmented image data from the display screen. The lens apparatus is configured to project the augmented image data to a focal distance different than a display surface of the display screen. The apparatus also comprises an image processor configured to generate the augmented image data from image data supplied to the image processor. The augmented image data is configured to correct for a distortion caused by the image data passing through the lens apparatus.

### CROSS-REFERENCE TO RELATED APPLICATION

This application claims priority to and the benefit under 35 U.S.C. § 119(e) of U.S. Provisional Patent Application No. 62/457,245, filed on Feb. 10, 2017, entitled “VEHICLE DISPLAY COMPRISING PROJECTION SYSTEM,” the entire disclosure of which is hereby incorporated herein by reference.

### TECHNOLOGICAL FIELD

The present invention generally relates to display devices for vehicles and more particularly to display devices configured to generate image data for ease of viewing a vehicular display.

### SUMMARY OF THE DISCLOSURE

According to one aspect of the present disclosure, a display apparatus for a vehicle is disclosed. The apparatus comprises a display screen configured to emit augmented image data in an emission direction. The apparatus further comprises a lens apparatus configured to receive the augmented image data from the display screen. The lens apparatus is configured to project the augmented image data to a focal distance different than a display surface of the display screen. The apparatus also comprises an image processor configured to generate the augmented image data from image data supplied to the image processor. The augmented image data is configured to correct for a distortion caused by the image data passing through the lens apparatus.

According to another aspect of the present disclosure, a method for displaying image data in a vehicle is disclosed. The method comprises processing image data to generate augmented image data. The augmented image data is restructured correcting for distortion caused by a lens apparatus. The method further comprises emitting the augmented image data from a display screen and transmitting the augmented image data through the lens apparatus. The method further comprises projecting the image data from the lens apparatus to a focal distance. The focal distance is located at a greater distance from a passenger of the vehicle than a viewing plane of the display screen.

According to yet another aspect of the present disclosure, a display apparatus for a vehicle is disclosed. The apparatus comprises an image sensor, a display screen, and a lens apparatus. The image sensor is configured to capture image data in a field of view comprising a scene proximate the vehicle. The display screen is configured to emit augmented image data in an emission direction, and the lens apparatus is configured to receive the augmented image data from the display screen. The lens apparatus is configured to project the augmented image data to a focal distance behind the display screen relative to a passenger of the vehicle. The apparatus further comprises an image processor in communication with the image sensor and configured to generate the augmented image data from image data. The augmented image data is configured to correct for a distortion caused by the image data passing through the lens apparatus.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a projected view demonstrating a display system of a vehicle;

FIG. 2 is an elevational view of a vehicle demonstrating an imaging apparatus of a vehicle;

FIG. 3 is a block diagram of an image processing method for generating augmented image data;

FIG. 4 is a schematic diagram of an image processing method for an occupant of a vehicle;

FIG. 5 is a top schematic view of a vehicle occupant viewing image data; and

FIG. 6 is a block diagram of a display system in accordance with the disclosure.

### DETAILED DESCRIPTION

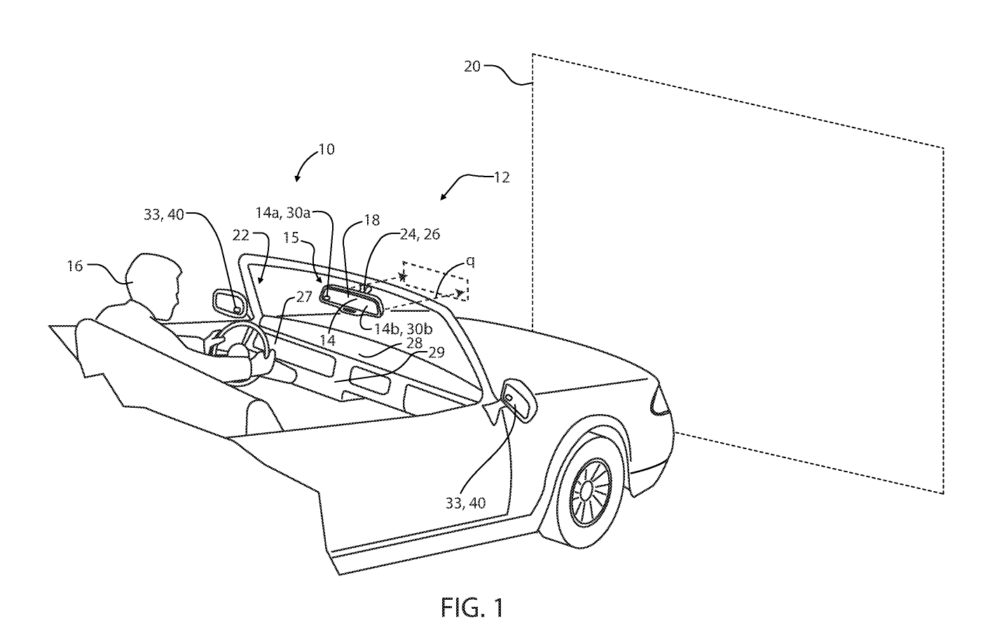

For purposes of description herein, the terms “upper,” “lower,” “right,” “left,” “rear,” “front,” “vertical,” “horizontal,” and derivatives thereof shall relate to the invention as oriented in FIG. 1. Unless stated otherwise, the term “front” shall refer to the surface of the element closer to an intended viewer of a display, and the term “rear” shall refer to the surface of the element further from the intended viewer of the display. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

Referring to FIG. 1, the disclosure provides for a display system 10 for a vehicle 12. The display system 10 may be operable to display image data on a display screen 14. In some embodiments, the display system 10 may comprise a focal distance correction feature 15. The focal distance correction feature 15 may be configured to adjust an apparent focal distance of the image data on the display screen 14 relative to an occupant 16 of the vehicle 12. The focal distance correction feature 15 may provide for relief of one or more forms of ocular strain, blurriness, and/or other various issues that may be associated with visual accommodation. In this way, the display system 10 provides for an improved viewing experience of the display screen 14.

Visual accommodation is the process by which eyes focus on objects at various distances. For example, accommodation occurs when changing focus from a nearby object (e.g. the display screen 14) to a far off object in a distant region 20. The amplitude or effective accommodation of humans typically declines with age and may further be complicated by various additional visual irregularities. For example, various visual disorders, including, but not limited to, latent hyperopia, myopia, presbyopia, and pseudomyopia may be related to or have adverse effects that can further exacerbate issues with accommodation. Some of these visual disorders may be treated with corrective lenses, but such treatments may further compound the issues related to accommodation. In order to limit the visual strain related to accommodation and related issues, the disclosure provides for the focal distance correction feature 15 configured to adjust the apparent focal distance of the display screen 14.

As demonstrated in FIG. 1, the display screen 14 may be located in a passenger compartment 22 of the vehicle 12 nearby the occupant 16. Accordingly, one or more issues in accommodation may be apparent when the occupant 16 adjusts focal distance from the nearby display screen 14 to a distant region 20 away from the vehicle 12. For example, one or more images shown on the display screen 14 of the display system 10 may appear blurred when viewed after looking at the distant region 20. Such issues may not typically be associated with conventional rearview mirrors (e.g. reflective mirrors without video displays) because the objects in the mirror appear to have a similar focal distance to objects in the distant region 20. That is, the reflected scenes demonstrated in conventional mirrors may already appear to have a focal distance similar to that of the distant region 20.

Difficulties adjusting between the distant region 20 and nearby objects in the passenger compartment 22 may be more prevalent for older operators (e.g. the occupant 16) of the vehicle 12. Due to a gradual loss of accommodation, older individuals may commonly have greater difficultly changing focus from the distant region 20 to nearby objects (e.g. objects in the passenger compartment 22). As discussed herein, nearby objects may correspond to objects within approximately 1 m from the occupant 16 (e.g. the display screen 14). The distant region 20 may correspond to distances greater than 2 m from the occupant 16. Accordingly, the occupant 16 may face challenges of eye strain as well as magnification correction when viewing nearby objects in the passenger compartment 22 while operating the vehicle 12.

The disclosure may provide for the display system 10 incorporating a focal distance correction feature 15 to limit a perceived difference in focal distance between the display screen 14 and one or more of far off objects in the distant region 20. In this way, the display system 10 may provide for improved visibility of a scene rearward from the vehicle 12 and limit eye strain that may otherwise result from adjustment or accommodation in focal distance from the display screen 14 to the distant region 20.

As discussed herein, the display system 10 may be configured to capture and display image data on the display screen 14. The image data may correspond to one or more scenes that may typically be visible in a rearview mirror. In some embodiments, the display system 10 may provide for the display of panoramic image data captured by one or more cameras or imaging devices on the display screen 14. Accordingly, the disclosure provides for various embodiments of the display system 10, some of which are described in detail in the following description.

Still referring to FIG. 1, in some embodiments, the disclosure may provide for the display system 10 to generate and display augmented image data on the display screen 14. The augmented image data may be configured to be emitted or projected from the display screen 14 to provide the occupant 16 with the visual perception that image data is projected behind the display screen 14 and/or in front of the vehicle 12. The augmented image data may be restructured (e.g. stretched, elongated, manipulated, etc.) and projected through a lens apparatus 18 or lens array in connection with the display screen 14 in order to provide the perception of originating from behind the display screen 14. In some embodiments, a projection distance q of the image data may be provided by the restructured or augmented image data emitted from the display screen 14 and passing through the lens apparatus 18 (e.g. one or more lenses, lens arrays, lenticular lenses, etc.).

The augmented image data projected through the lens apparatus 18 may be visually perceived by the occupant 16 at the projected distance q due to a focal point and/or magnification of the lens apparatus 18 projecting the perceived focal depth behind the display screen 14. For example, the lens apparatus 18 may be configured to adjust the focal depth of the display screen 14 such that a vergence angle of the binocular vision of the occupant 16 is expanded or increased to appear further away from the occupant 16 at the projected distance q. In various embodiments, the image data may also be augmented by the display system 10 to correct for distortion attributed to viewing the image data through the lens apparatus 18. In this way, the system 10 may provide for an improved viewing experience of the image data on the display screen 14 by projecting the perceived distance of the image data to the projected distance q.

In some embodiments, the lens apparatus 18 may comprise a neutral display region 30a configured to transmit the image data from the display screen 14 and/or icons or elements incorporated in a display apparatus 24 of the display system 10. The neutral display region 30a may correspond to an area, region, or zone of the lens apparatus 18 configured to transmit light (e.g. the image data) without optical correction. In this configuration, the image data emitted from the display screen 14 may be transmitted through the neutral display region 30a allowing the corresponding image data to “pass through” without substantial magnification or adjustment to the focal point such that the image data in the neutral display region 30a appears to originate from the display screen 14. That is, the neutral display region 30a may provide for a first portion 14a of the display screen configured to display visual information that appears to be located on a plane formed by a surface of the display screen 14 or the lens apparatus 18. The second portion 14b may correspond to a projected display region 30b configured to display visual information that appears to originate from the projected distance q.

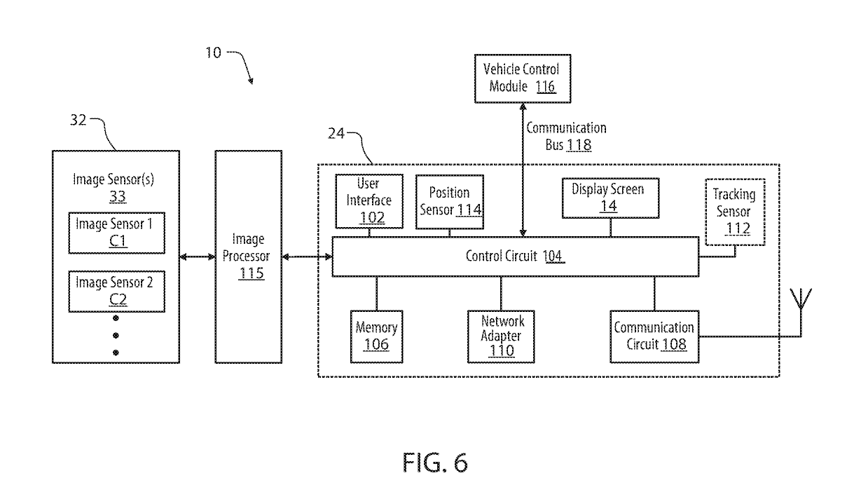

The neutral display region 30a may provide for the display screen to provide for one or more soft keys, which may be displayed on the display screen 14 as buttons, icons, graphics and/or text in the plane of the display screen 14. For example, in some embodiments, the display apparatus 24 may comprise a user interface comprising a sensory grid or touch-screen functionality. The user interface may be utilized in combination with the soft keys transmitted through the neutral display region 30a to provide for a human-machine interface (HMI). In this configuration, the display apparatus 24 may provide for the soft keys, buttons, text, or graphics to appear as though they originate from the display screen 14 through the neutral display region 30a. Further discussion regarding the user interface is discussed in reference to FIG. 6.

In some embodiments, the neutral display region 30a may be configured as a switchable optical correction mechanism, which may be referred to as a selective or switchable neutral display region. In this configuration, the switchable neutral display region may comprise a liquid crystal display (LCD) or various electro-optic elements that may be controlled by the system 10 to facilitate an “on demand” focal change feature. Accordingly, in a first configuration, the switchable neutral display region may shift or apply a correction to the image data emitted from the display screen 14 such that the image data appears to originate from the projected distance q. Additionally, in a second configuration, the switchable neutral display region may function as the neutral display region 30a allowing the corresponding image data to “pass through” without substantial magnification or adjustment to the focal point such that the image data in the neutral display region 30a appears to originate from the display screen 14.

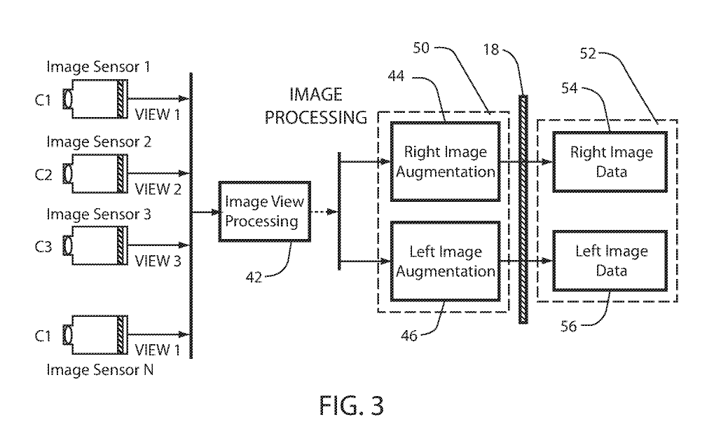

As discussed further in reference to FIGS. 3-5, the display system 10 may be configured to capture and display the image data or augmented image data on the display screen 14. The image data may comprise image data in the form of right eye image data or frames and left eye image data or frames. The right eye image data may be transmitted from the display screen 14 such that it is received by the right eye of the occupant 16. The left eye image data may be transmitted from the display screen 14 such that it is received by the left eye of the occupant 16. Accordingly, the display screen 14 may form a portion of a display apparatus 24 configured to project specific frames of the image data to each of the left eye and the right eye of the occupant 16.

According to various embodiments, the display apparatus 24 may comprise similar features to an autostereoscopic or automultiscopic display. The following references may include various implementations for display systems and camera systems configured to provide for autostereoscopic and/or automultiscopic functionality and are incorporated herein by reference in their entirety: U.S. Pat. No. 9,179,134 B2, entitled “MULTI-LAYER PLENOPTIC DISPLAYS THAT COMBINE MULTIPLE EMISSIVE AND LIGHT MODULATING PLANES,” filed Nov. 27, 2012, by Ranieri et al.; U.S. Patent Application Publication No. 2015/0334379 A1, entitled “DISPLAY UNIT FOR ROTATABLY DISPLAYING AN AUTOSTEREOSCOPIC PRESENTATION,” filed Dec. 24, 2012, by Lin Du et al; U.S. Pat. No. 6,377,295 B1, entitled “OBSERVER TRACKING DIRECTIONAL DISPLAY,” filed Apr. 23, 2002, by Graham Woodgate et al.; U.S. Pat. No. 9,843,776, entitled “MULTI-PERSPECTIVE STEREOSCOPY FROM LIGHT FIELDS,” filed Jul. 15, 2015, by Changil Kim et al.; U.S. Patent Application Publication No. 2014/0125783 A1, entitled “AUTOSTEREOSCOPIC IMAGE DISPLAY AND METHOD FOR DRIVING THE SAME,” filed Nov. 6, 2013, by Bogyun Chung et al.; U.S. Pat. No. 8,947,605 B2, entitled “IMAGE DATA PLACEMENT METHOD FOR A TIME MULTIPLEXED AUTOSTEREOSCOPIC DISPLAY,” filed Sep. 13, 2012, by Jesse B. Eichenlaub; and U.S. Patent Application Publication No. 2009/0282429 A1, entitled “VIEWER TRACKING FOR DISPLAYING THREE DIMENSIONAL VIEWS,” filed May 7, 2008, by Stefan Olsson et al.

As discussed herein, the display system 10 may be configured to generate separate images for the right eye and the left eye of the occupant 16. Additionally, the display system 10 may be configured to generate a plurality of views that may be associated with a plurality of image sensors. Embodiments of the display system 10 configured to provide for a plurality of views may utilize one or more stereoscopic display methods to communicate the image data to the left eye and the right eye independently. In this configuration, the display apparatus 24 may provide for views that may normally be shown on a rearview mirror and conventional side mirrors.

In some embodiments, the display apparatus may be configured to track the position of the occupant 16 in the passenger compartment 22. For example, the display apparatus 24 may comprise a sensor configured to track a location of a face and/or the eyes of the occupant 16. In this way, the display apparatus 24 may be operable to track a position of the eyes of the occupant 16 to control specific pixels in a pixel array 74 configured to target the left eye or the right eye. The eyes of the operator may be tracked by one or more tracking sensors that may be incorporated in a display apparatus 24. An example of a tracking sensor is discussed further in reference to FIG. 6.

In various embodiments, the lens or lens apparatus 18 of the display apparatus 24 may correspond to a parallax-based lens array, a lenticular sheet, and/or a fish-eye array. Such display technologies may be used to provide an autostereoscopic or automultiscopic experience for the occupant 16, which may provide for a projected view of the display screen 14. Parallax-based displays may incorporate a parallax barrier and/or employ horizontally modulated blocking patterns to communicate different frames of image data to the first eye and the second eye of the occupant 16. The parallax barrier may correspond to a device that may be placed in front of the display screen 14, such as a liquid crystal display (LCD) or other displays, to allow the display screen 14 to show or display a stereoscopic or image data projected to the focal plane at the projected distance q without the need for the viewer to wear complementary active or passive stereoscopic lenses (e.g. 3D glasses). The parallax barrier may include a layer of material with a series of precision slits that allow each eye of a viewer to see a different set of pixels.

In an exemplary embodiment, the display apparatus 24 of the display system 10 may be incorporated in an interior rearview assembly 26. The display apparatus 24 may be mounted or otherwise attached to a vehicle 12 in a variety of locations. For example, the display apparatus 24 may be integrated into a gauge cluster 27, a dashboard 28, a center stack 29 (e.g., infotainment center), side mirrors, and/or a headliner of the vehicle 12. The display apparatus 24 may be located in other peripheral locations. For example, the display apparatus 24 may be mounted to a visor. The display apparatus 24 may be mounted to other surfaces of a vehicle 12 (e.g. windshield, door panel, or other vehicle components).

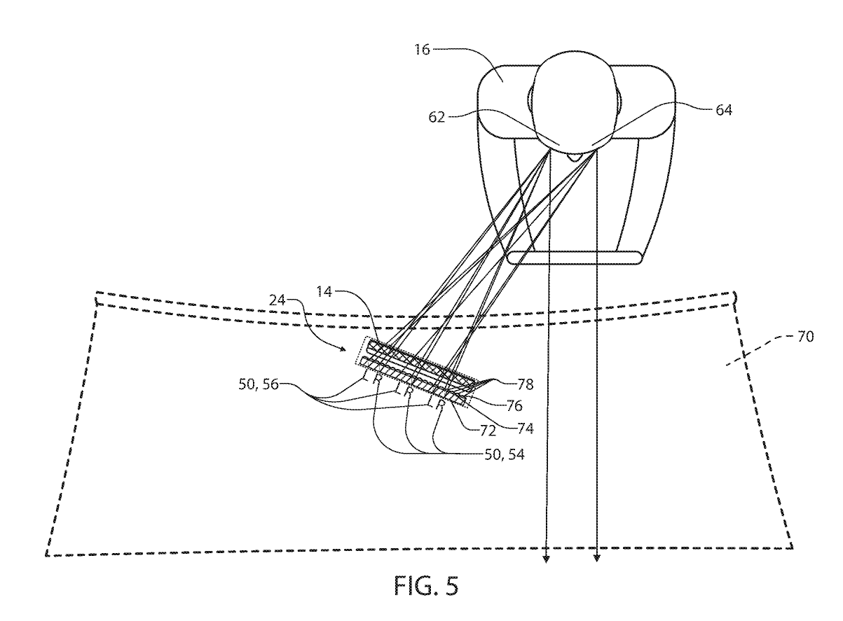

The display apparatus 24 may be configured to form a thin assembly by limiting a space between the lens apparatus 18 and a display panel configured to output image data. The thin assembly may enable practical applications of the display apparatus 24 by utilizing an array of lenses to form the lens apparatus 18. By utilizing an array of lenses or similar optical configurations (e.g. a parallax-based lens array, a lenticular sheet, and/or a fish-eye lens array), a spacing between the display panel and the lens apparatus 18 may be minimized. Accordingly, an array of lenses may be utilized for the lens apparatus 18, which may provide for the display apparatus 24 to be housed in a small package suitable for use in the vehicle 12. An example of the lens apparatus 18 implemented in the rearview assembly as a lenticular lens is discussed further in reference to FIG. 5. Though a lenticular lens is demonstrated in the exemplary embodiment of FIG. 5, various lenses or arrays of optical devices may be similarly implemented as the lens apparatus 18 in accordance with the disclosure.

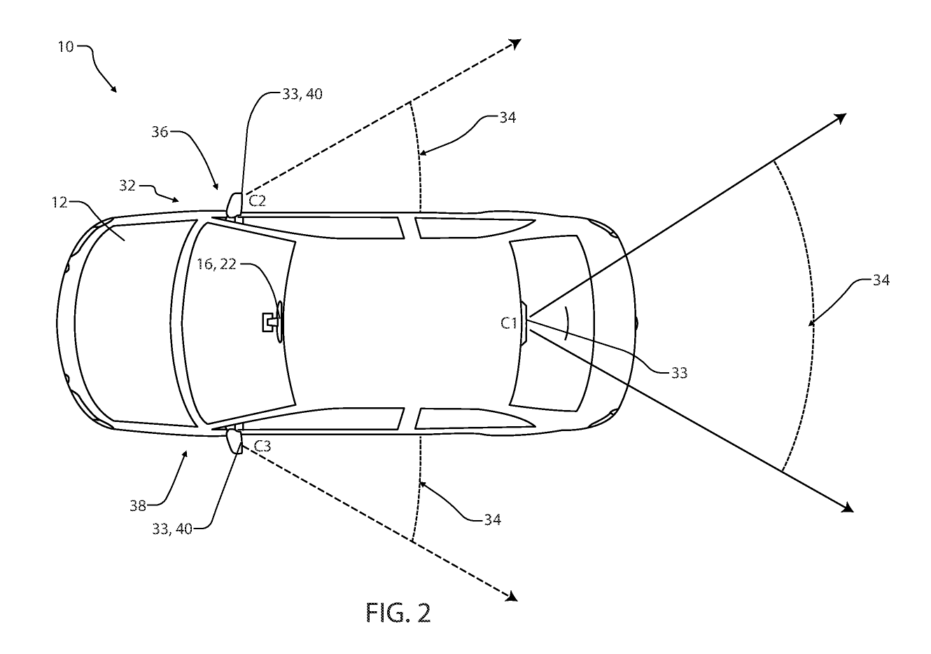

Referring now to FIG. 2, a diagram of an imaging apparatus 32 of the vehicle 12 is shown. In an exemplary embodiment, a plurality of image sensors 33 of the imaging apparatus 32 may correspond to a first image sensor C1, a second image sensor C2, and a third image sensor C3. Each of the image sensors 33 may have a field of view 34 focusing on an environment proximate the vehicle 12. In the various implementations discussed herein, the image sensors C1-C3 may be implemented to provide views of the environment proximate the vehicle 12 that may be displayed on the display screen 14 or any form of display device.

The image sensors 33 may be arranged in various locations on the vehicle 12. In an exemplary embodiment, the image sensors 33 may be arranged such that each of a plurality of fields of view 34 of the image sensors C1-C3 is configured to capture a significantly different portion of the surrounding environment. Each of the image sensors 33 may comprise any form of device configured to capture image data, for example Charge Coupled Device (CCD) and Complementary Metal Oxide Semiconductor (CMOS) image sensors. Though three image sensors C1, C2, and C3 are discussed in reference to the present implementation, the number of image sensors may vary based on the specifications of the particular image sensors and/or a desired number of fields of view 34 for the display system 10.

The image sensors C1, C2, and C3 are disposed on the vehicle 12 and oriented such that each field of view 34 of the image sensors 33 is directed toward a substantially different region. A first image sensor C1 may be disposed centrally on a rear facing portion of the vehicle 12 proximate a tailgate or similar area of the vehicle 12. In some embodiments, the image sensor C1 may be disposed proximate a rear-bumper and/or a center high mount stop light (CHMSL). A second image sensor C2 and a third image sensor C3 may be disposed on a passenger's side 36 and a driver's side 38 of the vehicle 12, respectively. The second image sensor C2 and the third image sensor C3 may be configured to capture image data corresponding to the environment proximate the side regions of the vehicle 12.

In some implementations, the second image sensor C2 and the third image sensor C3 may be disposed in side mirrors 40 of the vehicle 12. The image sensors C2 and C3, in combination with the first image sensor C1, may be configured to capture image data corresponding to a rearward-directed region relative the forward direction of the vehicle 12. In some embodiments, the image sensors 33 may be configured to capture an increased or decreased viewing angle depending on the particular application. In some embodiments, the image sensors 33 may be configured to capture approximately the entire environment surrounding the vehicle 12.

As discussed further in reference to FIG. 3, the image sensors 33 may be in communication with the image processor configured to process image data from each of the fields of view 34 captured by the image sensors 33. The image processor may be configured to generate augmented image data from the fields of view 34 for each of the right eye and the left eye of the occupant 16. In this configuration, the display system 10 may provide for an enhanced viewing experience by controlling the image data to provide a visual perception for the occupant 16 that the image data originates from behind the display screen 14 at a projected distance q. Though discussed in detail in reference to the interior rearview assembly 26, the display system 10 may be utilized in various portions of the vehicle (e.g. a vehicle console, gage cluster, side mirrors, etc.). As such, the disclosure provides for various embodiments of vehicle displays that may be utilized for a variety of applications.

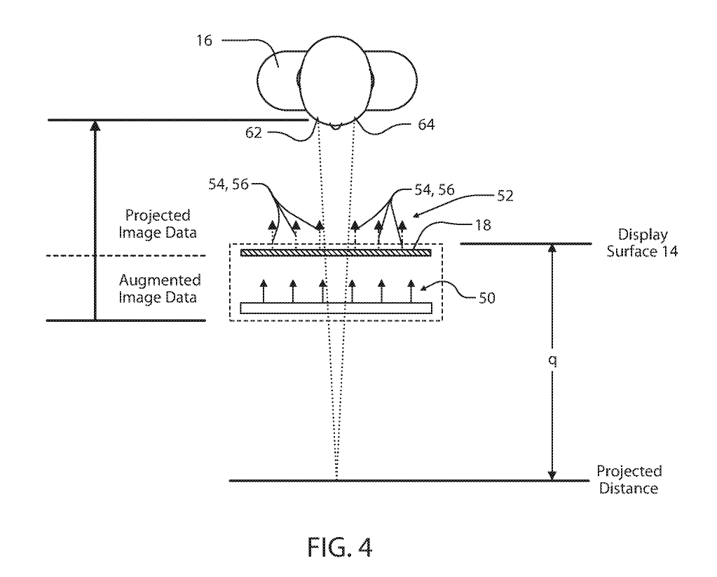

Referring now to FIGS. 3 and 4, diagrams of an image processing method that may be processed by the image processor are shown. The image processor may receive image data from one or more of the image sensors C1, C2, and C3 and encode or process the image data for demonstration on the display screen 14. For example, the first image sensor C1 may provide for a first view (VIEW 1), the second image sensor C2 may provide for a second view (VIEW 2), and the third image sensor C3 may provide for a third view (VIEW 3). The image views may be processed by the image processor, which may comprise each of the views being cropped, enhanced, stitched, and/or composited for display on the display screen 14 (42).

The image data received from the image processor may further be processed according to one or more augmentation or correction algorithms to generate augmented image data 50. In some embodiments, the augmented image data 50 may comprise a right image augmentation (44) and a left image augmentation (46). The augmentation or processing of the image data may comprise restructuring of various portions or segments of the image data to correct for a distortion of the lens apparatus 18 and/or facilitate lateral movement of the focal point of the eyes of the occupant 16. For example, the augmentation or processing of the image data may comprise parsing segments or portions of the image data such that the augmented image data 50 has an appropriate amount of overlap to facilitate lateral movement of the focal point to facilitate the image data to be perceived at the projected distance q after being transmitted through the lens apparatus 18. The processing or augmentation may result in a grid like restructuring or stretching of the image data in the vertical and horizontal display dimensions. In this way, display system 10 may provide the perception of the image data projected from the display screen 14 to appear as though it is originating from behind the display screen 14, while also correcting for a distortion caused by the projection.

The augmented image data 50 from the display screen 14 may be emitted from the display screen 14 into the lens apparatus 18. The image data may then be projected to the occupant 16 as projected image data 52. In some embodiments, the projected image data 52 may comprise right image data (54) and left image data (56). In this way, the display apparatus 24 may be configured to display the image data within the passenger compartment 22 having an appearance of originating from the projected distance q. The projected distance q may vary based on the desired design and configuration of the display apparatus 24. For example, the projected distance q or the display distance may be greater than or equal to 400 mm and may be adjusted to greater than a meter. Additionally in some embodiments, the focal point of the lens apparatus 18 (or lens array) may be defined as being located at optical infinity. By providing the perception to the occupant 16 that the image data originates from the projected distance q, the display apparatus 24 may serve to limit or alleviate accommodation issues associated with viewing the nearby image data on the display screen 14 and objects located in the distant region 20.

As discussed herein, in some embodiments, the system 10 may be operable to generate image data for an autostereoscopic display. Referring now to FIGS. 4 and 5, the display apparatus 24 is shown projecting the right image data 54 and the left image data 56 in order to provide for independent correction of the augmented image data 50 for a right eye 62 and a left eye 64 of the occupant 16. The display system 10 may be configured to communicate right image data 54 to the right eye 62 and left image data 56 to the left eye 64. As discussed herein, the display apparatus 24 may correspond to an autostereoscopic display device configured to project the right image data 54 to the right eye 62 and the left image data 56 to the left eye 64. In this configuration, the display system 10 may communicate the image data to the occupant 16 to provide the perception that the image data originates at the projected distance q.

As shown in FIG. 5, the display apparatus 24 is shown in reference to a windshield 70 of the vehicle 12. To provide such functionality, the display apparatus 24 may comprise a display panel 72 corresponding to a pixel array 74 and a lenticular lens 76 formed on the display panel 72. A rear surface of the display screen 14 may face the lenticular lens 76. The display panel 72 may be a variety of display types, which may be the pixel array 74. The pixel array 74 may be arranged in rows and columns. For example, the display panel 72 may correspond to a liquid crystal display (LCD), a plasma display, an organic light emitting diode (OLED) display, a field emission display (FED) panel, or various other displays.

The lenticular lens 76 may comprise long cylindrical lens elements 78. The lens elements 78 may be arranged in parallel and be aligned with the columns of the pixel array 74. Accordingly, the lenticular lens 76 may be disposed over the display panel 72. The lenticular lens 76 may separate the right image data 54 from the left image data 56 based on a location of each pixel relative to the cylindrical elements 78. In this way, the display apparatus 24 may be configured to direct the right image data 54 to the right eye 62 and the left image data 56 to the left eye 64.

As demonstrated in FIG. 5, the display apparatus 24 may be configured to form a thin assembly by limiting a space between the lens apparatus 18 (e.g. the lenticular lens 76) and the display panel 72. The thin assembly may enable practical applications of the display apparatus 24 by utilizing an array of lenses to form the lens apparatus 18. In such embodiments, the array of lenses or similar optical configurations (e.g. a parallax-based lens array, a lenticular sheet, and/or a fish-eye lens array) may be implemented to minimize a spacing between the display panel 72 and the lens apparatus 18. Accordingly, an array of lenses may be utilized for the lens apparatus 18, which may provide for the display apparatus 24 to be housed in a small package suitable for use in the vehicle 12. Though the lenticular lens 76 is demonstrated in the exemplary embodiment of the lens apparatus 18 in FIG. 5, various lenses or arrays of optical devices may be similarly implemented without departing from the spirit of the disclosure.

Referring now to FIG. 6, a block diagram of the display system 10 is shown. The display system 10 may include a user interface 102 in the form of one or more buttons in communication with a control circuit 104. The user interface 102 may provide for the display system 10 to receive one or more inputs to control operational settings, some of which are discussed herein. An exemplary embodiment of the display apparatus 24 may incorporate the elements shown in the dashed line box designated as the display apparatus 24. In some embodiments, the user interface 102 may include input devices, such as touchscreen displays, switches, microphones, knobs, touch sensors (e.g., projected capacitance sensor resistance based touch sensor, resistive touch sensor, or other touch sensor), proximity sensors (e.g., projected capacitance, infrared, ultrasound, infrared, or other proximity sensor), or other hardware configured to generate an input from a user action.

The display system 10 may comprise the display apparatus 24. The display apparatus 24 may comprise the display panel 72 comprising the pixel array 74 and a lenticular lens 76 proximate the display panel 72. The display panel 72 may be a variety of display types having the pixel array 74, which may be arranged in rows and columns. For example, the display panel 72 may correspond to a liquid crystal display (LCD), a plasma display, an organic light emitting diode (OLED) display, a field emission display (FED) panel, or various other displays. The display apparatus 24 may further incorporate a speaker, haptic feedback device (e.g., vibration motor), LEDs, or other hardware component for providing an output.

The control circuit 104 may include various types of control circuitry, digital and/or analog, and may include a microprocessor, microcontroller, application-specific integrated circuit (ASIC), graphics processing unit (GPU), or other circuitry configured to perform various input/output, control, analysis, and other functions to be described herein. In other embodiments, the control circuit 104 may be a system on a chip (SoC) individually or with additional hardware components described herein. The control circuit 104 may further include a memory 106 (e.g., random access memory, read only memory, flash memory, hard disk storage, flash memory storage, solid state drive memory, etc.). In further embodiments, the control circuit 104 may function as a controller for one or more hardware components included in the display system 10. For example, the control circuit 104 may function as a controller for a touchscreen display or other operator input device, a controller for a transceiver, transmitter, receiver, or other communication device (e.g., implement a Bluetooth communications protocol).

In some embodiments, the control circuit 104 may be configured to receive inputs from the user interface 102. The inputs may be converted into control signals that may be identified and utilized to output one or more control signals and/or transmit data. In this configuration, the display system 10 may communicate (e.g. send and/or receive signals and/or data) to control various functions of the display or settings or functions of the vehicle 12.

The memory 106 may be used to facilitate the functions of the display system 10 as described herein. Memory 106 may include computer code modules, data, computer instructions, or other information which may be executed by the control circuit 104 or otherwise facilitate the functions of the display system 10 described herein. For example, memory 106 may include encryption codes, pairing information, identification information, device registry configurations, image augmentation information, etc. The memory 106 and/or the control circuit 104 may facilitate the functions described herein using one or more programming techniques, data manipulation techniques, and/or processing techniques, such as using algorithms, routines, lookup tables, arrays, searching, databases, comparisons, instructions, etc.

The display system 10 may further comprise a communication circuit 108. The communication circuit 108 may correspond to a transceiver circuit or transmitter circuit coupled to the control circuit 104. The transceiver circuit may provide for the display system 10 to transmit and/or receive wireless communication signals. The wireless communication signals may be transmitted to or received from a variety of wireless devices (e.g., an original transmitter, home electronic device, mobile communications device, and/or remote device). The communication circuit 108 may be controlled by the control circuit 104. For example, the control circuit 104 may turn on or off the communication circuit 108, the control circuit 104 may send data using the communication circuit 108, format information, an activation signal, control signal, and/or other signal or data for transmission via the communication circuit 108, or otherwise control the communication circuit 108. Inputs from the communication circuit 108 may also be received by the control circuit 104. For example, software configurations, updates, user settings and other information may be received by the communication circuit 108 and stored in the memory 106 by the control circuit 104.

The control circuit 104 may be also coupled to a network adapter 110, receivers, and/or transmitters. In some embodiments, the network adapter 110 may be configured to communicate with the image sensors 33. In some embodiments, the network adapter 110 may be or include a cellular transceiver. In this configuration, the display system 10 may use the network adapter 110 and/or an additional transceiver (e.g., a cellular transceiver) to access the internet, other networks, and/or network hardware. In some embodiments, the display system 10 may access the internet, other networks, and/or network hardware through an intermediate device in communication with the display system 10, such as the mobile device.

In an exemplary embodiment, the network adapter 110 may be configured to send/receive data and/or control signals to a mobile device. The network adapter 110 may communicate via various wireless communication protocols. For example, communication protocols may include, but are not limited to, Bluetooth™ (e.g., a Bluetooth low energy (BLE), Wi-Fi (IEEE 802.11), ZigBee®, cellular, etc.), a wired interface and/or protocol (e.g., Ethernet, universal serial bus (USB), Firewire®, etc.), or other communications connection (e.g. infrared, optical, ultrasound, etc.).

In some embodiments, the display system 10 may track a position of the occupant 16 or a viewer (e.g. a position of the eyes of the occupant 16) with the tracking sensor 112. The tracking sensor 112 may be implemented as an ultrasound sensor, an infrared sensor, a camera sensor/imager, a heat detector, etc. In general, the tracking sensor 112 may identify a position of the occupant 16 such that an image processor 115 may generate views of image data (e.g. the augmented image data) from the image sensors 33. The augmented image data 50 may correspond to views that appear to the occupant 16 as though they are projected at the projected distance q.

In some embodiments, the display system 10 may comprise a position sensor 114 configured to identify a position or orientation of the display apparatus 24 relative to a forward direction of the vehicle 12. The position sensor 114 may correspond to an electrical or electromechanical sensor (e.g. an encoder, potentiometer, proximity sensor, compass, gyroscope, etc.), and may be configured to identify an angle of the display apparatus 24 or the display screen 14 relative to the forward direction of the vehicle 12. In this way, the image processor 115 may be operable to process the image data to select a plurality of views to generate the image data based on the angle of the display screen 14.

The control circuit 104 may be in communication with a vehicle control module 116 via a communication bus 118 of the vehicle 12. The communication bus 118 may be configured to deliver signals to the control circuit 104 identifying various states of the vehicle 12. For example, the communication bus 118 may be configured to communicate an operating condition of the vehicle 12 (e.g. the ignition is active, a gear selection, a lighting activation or setting, etc.), an ambient light level, a seat occupancy, a door ajar signal, driver/occupant identity or any other information or control signals that may be communicated via the communication bus 118. In this way, the control circuit 104 may communicate with the vehicle control module 116 to identify a variety of conditions and/or settings of the vehicle 12.

In some embodiments, the display system 10 may be a display similar to those disclosed in the following references. Examples of display assemblies that may be utilized with the disclosure may include U.S. Pat. No. 6,572,233 entitled “REARVIEW DISPLAY MIRROR,” U.S. Pat. No. 8,237,909 entitled “VEHICULAR REARVIEW MIRROR ASSEMBLY INCLUDING INTEGRATED BACKLIGHTING FOR A LIQUID CRYSTAL DISPLAY (LCD),” U.S. Pat. No. 8,411,245 entitled “MULTI-DISPLAY MIRROR SYSTEM AND METHOD FOR EXPANDED VIEW AROUND A VEHICLE,” and U.S. Pat. No. 8,339,526 entitled “VEHICLE REARVIEW MIRROR ASSEMBLY INCLUDING A HIGH INTENSITY DISPLAY,” which are incorporated herein by reference in their entirety.

The following references may include various implementations for imager systems providing rearward facing panoramic views and are incorporated herein by reference in their entirety: U.S. Pat. No. 8,237,909 B2, entitled “VEHICLE REARVIEW MIRROR ASSEMBLY INCLUDING INTEGRATED BACKLIGHTING FOR A LIQUID CRYSTAL DISPLAY (LCD),” filed Feb. 6, 2009, by John B. Ostreko et al.; and U.S. Pat. No. 8,411,245, entitled “MULTI-DISPLAY MIRROR SYSTEM AND METHOD FOR EXPANDED VIEW AROUND A VEHICLE,” filed Sep. 30, 2009, by Ethan J. Lee et al. Though the display system 10 in the various implementations disclosed herein is shown incorporated in a rearview display system, a display may similarly be incorporated in a vehicle forward center console, as a heads up display, or in any other location that may be visible to an operator or occupant 16 of the vehicle 12.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A display apparatus for a vehicle comprising:
a display screen configured to emit augmented image data in an emission direction;
a lens apparatus configured to receive the augmented image data from the display screen, wherein the lens apparatus is configured to project the augmented image data to a focal distance different than a display surface of the display screen; and
an image processor configured to generate the augmented image data from image data supplied to the image processor, wherein the augmented image data is configured to correct for a distortion caused by the image data passing through the lens apparatus.

2. The display system according to claim 1, wherein the focal distance is projected in a projection direction opposite the emission direction.

3. The display system according to claim 1, wherein the display surface of the display screen is located at a display distance from a passenger of the vehicle and the focal distance is greater than the display distance relative to the passenger.

4. The display system according to claim 1, further comprising:
at least one image sensor configured to capture the image data in a field of view comprising a scene proximate to the vehicle and supply the image data to the image processor.

5. The display system according to claim 1, wherein the lens apparatus comprises a lens array configured to project the augmented image data to the focal distance by controlling a parallax effect of the augmented image data.

6. The display system according to claim 1, wherein the display apparatus is an autostereoscopic display.

7. The display system according to claim 1, wherein the display apparatus corresponds to a rearview video display apparatus.

8. The display system according to claim 1, wherein the display screen comprises a first portion and a second portion, wherein the first portion is configured to display a first portion of the image data on a plane formed by the display screen and the second portion is configured to display a second portion of the image data visually projected to the focal distance.

9. The display system according to claim 8, wherein the first portion is configured to display at least one graphic corresponding to a soft key of a user interface.

10. The display system according to claim 8, wherein the image processor is further configured to control the visual projection of the first portion from the display plane to focal distance.

11. A method for displaying image data in a vehicle, the method comprising:
processing image data to generate augmented image data, wherein the augmented image data is restructured correcting for distortion caused by a lens apparatus;
emitting the augmented image data from a display screen;
transmitting the augmented image data through the lens apparatus; and
projecting the image data from the lens apparatus to a focal distance, wherein the focal distance is located at a greater distance from a passenger of the vehicle than a viewing plane of the display screen.

12. The method according to claim 11, further comprising:
capturing the image data comprising a scene proximate the vehicle.

13. The method according to claim 12, wherein the scene comprises a rearward directed field of view relative to a forward operating direction of the vehicle.

14. The method according to claim 11, further comprising:
independently generating the augmented image data for a right eye of the passenger as right eye image data and a left eye of the passenger as left eye image data.

15. The method according to claim 14, further comprising:
tracking a location of a first location of the right eye and a second location of the left eye of the passenger.

16. The method according to claim 15, further comprising:
projecting the right eye image data to the first location and the left eye image data to the second location.

17. The method according to claim 16, further comprising:
projecting the right eye image data and the left eye image data from a pixel array to the first location and the second location by selectively activating pixels of the pixel array aligned with the first location and the second location through the lens apparatus.

18. A display apparatus for a vehicle comprising:
at least one image sensor configured to capture image data in a field of view comprising a scene proximate the vehicle;
a display screen configured to emit augmented image data in an emission direction;
a lens apparatus configured to receive the augmented image data from the display screen, wherein the lens apparatus is configured to project the augmented image data to a focal distance behind the display screen relative to a passenger of the vehicle; and
an image processor in communication with the image sensor and configured to generate the augmented image data from image data, wherein the augmented image data is configured to correct for a distortion caused by the image data passing through the lens apparatus.

19. The display system according to claim 18, wherein the display screen is located at a display distance from the passenger of the vehicle and the focal distance is greater than the display distance relative to the passenger.

20. The display system according to claim 1, wherein the lens apparatus comprises a lens array configured to project the augmented image data to the focal distance by controlling a parallax effect of the augmented image data.
